(19) United States
(12) Patent Application Publication
(10) Pub. No.: US 2012/0092625 A1
(43) Pub. Date: Apr. 19, 2012

(54) PROJECTOR

(75) Inventor: Kazuya Minami, Hirakata-shi (JP)

(73) Assignee: SANYO ELECTRIC CO., LTD., Osaka (JP)

(21) Appl. No.: 13/270,693

(22) Filed: Oct. 11, 2011

(30) Foreign Application Priority Data
Oct. 13, 2010 (JP) 2010-230904

(51) Int. Cl. G03B 21/14

(52) U.S. Cl. 353/33

(57) ABSTRACT

A projector including light valves respectively corresponding to red light, green light, and blue light. A color combining prism (e.g., cross dichroic prism) combines modulated light emitted from the light valves. A projection lens enlarges and projects the combined light from the color combining prism. An aberration correction lens corrects a chromatic aberration of magnification of the projection lens. A pressing member resiliently presses and fixes the aberration correction lens to the color combining prism at a light entrance surface for at least one of the red, green, and blue light.

### CROSS-REFERENCE TO RELATED APPLICATIONS

This application is based upon and claims the benefit of priority from prior Japanese Patent Application No. 2010-230904, filed on Oct. 13, 2010, the entire contents of which are incorporated herein by reference.

### BACKGROUND OF THE INVENTION

The present invention relates to a projector that separates white light from a light source lamp into red, green, and blue light, modulates the red, green, and blue light with a liquid crystal panel, combines the modulated light, and enlarges and projects the combined light onto a screen with a projection lens.

A known projector forms an image with an image display panel, such as a liquid crystal panel, and enlarges and projects the image onto a screen with a projection lens. A typical example of such a projector is a so-called three-chip LCD projector that uses, for example, liquid crystal panels for red, green, and blue light to display a color image.

In the three-chip LCD projector, for example, white light from a white light source lamp is collimated by a reflector or the like. A color separation system separates the light into three colors of light, namely, red light, green light, and blue light. An LCD panel is provided for each light. Each color of light enters the corresponding LCD panel. Each LCD panel light-modulates the light of the corresponding color and adds contrast to the light. A color combining prism combines the light for each color. The color-combined light is then projected by a projection lens onto a screen. The projection lens is formed by a plurality of lenses. The projection lens performs aberration correction on the white light and forms a projected image that has little distortion and color deviation.

In such a three-chip LCD projector, the chromatic aberration performed by the projection lens is insufficient. Thus, a chromatic aberration of magnification is present in the projector. As a result, the magnification rate differs between the red, green, and blue colors that are projected onto the screen, and a convergence deviation between the red, green, and blue color occurs in part of the image. In principle, the aberration of red light and blue light occurs in a direction that is opposite to the aberration of the green light. When attempting to resolve such conversion deviation with the combination of the lens forming the projection lens, the number of lenses increases. This increases the size and weight of the projection lens. Further, the influence of the chromatic aberration of magnification on an image in the LCD projector is subtly noticeable when using LCD panels having a large pixel size. However, due to the reduction in the pixel size of the liquid crystal panels over these recent years, the influence of the chromatic aberration of magnification can no longer be ignored.

To cope with such a problem, an aberration correction lens, which corrects the chromatic aberration of magnification, is arranged separately from the projection lens between the LCD panels and the color combining prism. The aberration correction lens is a convex lens, which has a positive refraction index at the light emission side, or a concave lens, which has a negative refraction index at the light emission side. When using the convex lens, the projection magnification is increased. When using the concave lens, the projection magnification is decreased.

The present invention is related to a coupling structure for such an aberration correction lens. Examples of such coupling structures in the prior art will now be described.

Japanese Laid-Open Patent Publication No. 2001-66695 describes a first prior art example of a coupling structure, which is shown in FIG. 10. The coupling structure includes first, second, and third LCD panels 101R, 101G, and 101B respectively corresponding to red light, green light, and blue light. The coupling structure also includes a color combining prism 102. The first to third LCD panels 101R, 101G, and 101B light-modulates the light of the corresponding color. The color combining prism 102 combines the modulated light from the first to third LCD panels 101R, 101G, and 101B. An aberration correction lens 103 is arranged between the color combining prism 102 and each of the first to third LCD panels 101R, 101G, and 101B to correct the chromatic aberration of magnification. The color combining prism 102 is a cross-dichroic prism. Further, a field lens 104, which collimates light, is arranged at the light entrance side of each of the first to third LCD panels 101R, 101G, and 101B. A projection lens 105 is arranged at the light emission side of the color combining prism 102. Clearances are provided between the first to third LCD panels 101R, 101G, and 101B, the color combining prism 102, the aberration correction lens 103, the field lenses 104, and the projection lens 105 to allow passage of a cooling current.

In this example, the aberration correction lens 103 is arranged in the red light system and the blue light system. Japanese Laid-Open Patent Publication No. 2001-66695 also describes a simplified layout in which the aberration correction lens 103 is arranged only in one system, such as the red color system, and a layout in which the aberration correction lens 103 is arranged in each of the three systems for red light, green light, and blue light to perform accurate correction.

Japanese Laid-Open Patent Publication No. 2001-66695 describes a second prior art example of a coupling structure. In the same manner as the first prior art example, the coupling structure of the second prior art example arranges the aberration correction lens 103 between the color combining prism 102 and each of the first to third LCD panels 101R, 101G, and 101B. However, the coupling structure of the second prior art example differs from the first prior art example in the coupling of the aberration correction lens 103. More specifically, as shown in FIG. 11, in the coupling structure of the prior art example, the aberration correction lens 103 is adhered to light entrance surfaces of the color combining prism 102.

Japanese Laid-Open Patent Publication No. 2003-344804 describes a third prior art example of a coupling structure. In the coupling structure of the third prior art example, an aberration correction lens is adhered to the light emission surface of each of the first to third LCD panels 101R, 101G, and 101B. FIGS. 12 and 13 specifically show the coupling structure of the third prior art example using a liquid crystal light valve for red light as an example.

FIG. 12 shows an example of the periphery of the liquid crystal light valve for red light. The liquid crystal light valve includes a condenser lens 201, an LCD panel 202, and a color combining prism 203, which is formed by a cross dichroic prism, arranged in the order in which light travels. An entrance polarization plate 204 is adhered to a light entrance surface of the condenser lens 201. An emission polarization plate 205 is adhered to a light entrance surface of the color combining prism 203. An aberration correction lens 206 (planoconvex lens) is adhered to a light emission surface of the LCD panel 202. As shown in FIG. 12, a cooling fan 207 draws in ambient air 208 to cool the condenser lens 201, LCD panel 202, color combining prism 203, entrance polarization plate 204, emission polarization plate 205, and aberration correction lens 206.

As shown in FIG. 13, the LCD panel 202 includes a liquid crystal layer 202a, first and second transparent substrates 202b and 202c, which sandwich the liquid crystal layer 202a, and a panel holding frame 202d, which holds the entire LCD panel 202. The aberration correction lens 206 is adhered to the light emission side of the transparent substrate 202c, which is located at the light emission side of the LCD panel 202.

In the coupling structure of the first prior art example, the light absorptance of the aberration correction lens 103 is low. Thus, the amount of generated heat is small. However, unnecessary clearance is provided at the rear side of the aberration correction lens 103. This enlarges the area occupied by the optical engine.

The coupling structure of the second prior art example differs from that of the first prior art example in that there is no unnecessary clearance. However, when the aberration correction lens 103 is adhered to the color combining prism 102 with an adhesive agent, the adhesive agent absorbs heat. This increases the temperature of the adhesive agent. As a result, the durability of the adhesive agent may be shortened. Further, when the projection pixel is small, it is difficult to accurately adhere the aberration correction lens 103 to the color combining prism 102.

In the coupling structure of the third prior art example, the aberration correction lens 206 is adhered to the light emission side of the transparent substrate 202c, which is located at the light emission side of the LCD panel 202. Thus, like the second prior art example, the coupling structure of the third prior art also has problems related to the influence of heat absorption and adhering accuracy. Further, in this case, the cooling effect of the ambient air on the LCD panel 202 is decreased.

### SUMMARY OF THE INVENTION

One aspect of the present invention is a projector including three light valves respectively corresponding to red light, green light, and blue light. The light valves modulate the light of the corresponding color. A color combining prism combines the modulated light from the light valves. The color combining prism includes three light entrance surfaces respectively corresponding to the light valves to receive the modulated light of the corresponding color. A projection lens enlarges and projects the combined light from the color combining prism. At least one aberration correction lens is arranged in at least one of three paths respectively corresponding to the red light, green light, and blue light and extending from the light valves to the light entrance surfaces. The aberration correction lens corrects a chromatic aberration of magnification of the projection lens. At least one pressing member that resiliently presses and fixes the at least one aberration correction lens to the light entrance surface of the color combining prism.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing an LCD projector according to one embodiment of the present invention;

FIG. 2 is a schematic diagram showing the periphery of liquid crystal light valves in the LCD projector of FIG. 1;

FIG. 3 is a perspective view showing a color combining prism unit including part of a liquid crystal light valve in the LCD projector of FIG. 1;

FIG. 4 is a perspective view showing the color combining prim unit from which part of the liquid crystal light valve is removed in FIG. 3;

FIG. 5 is an exploded perspective view showing red light emission side components in FIG. 4;

FIG. 6 is a side view showing a red light entrance side in FIG. 4;

FIG. 7 is a side view showing the red light entrance side in a state in which a pressing member is removed in FIG. 6;

FIG. 8 is a cross-sectional view showing the pressing member of FIG. 6 taken in a vertical direction at a laterally central position;

FIG. 9 is a cross-sectional view taken along line A-A in FIG. 4;

FIG. 10 is a schematic diagram showing the periphery of a color combining prism in an LCD projector of the prior art;

FIG. 11 is a diagram showing a red light entrance surface of the color combining prism in another LCD projector of the prior art;

FIG. 12 is a schematic diagram showing the periphery of an LCD panel in a further LCD projector of the prior art; and

FIG. 13 is a cross-sectional view showing the LCD panel of FIG. 13.

### DETAILED DESCRIPTION OF THE INVENTION

A projector according to one embodiment of the present invention will now be described.

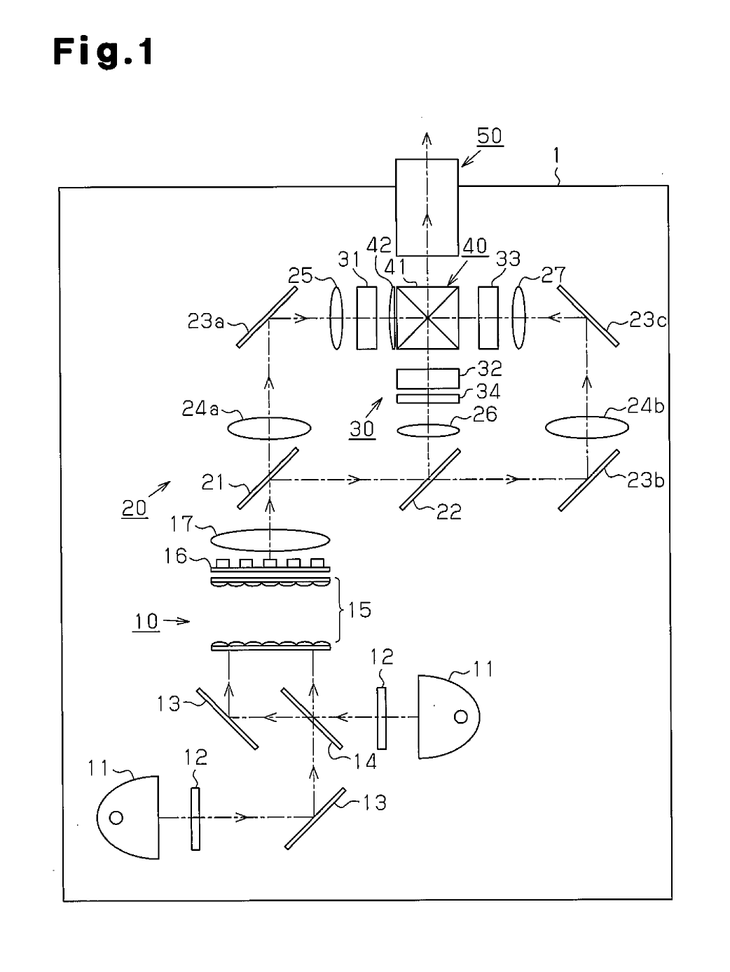

FIG. 1 is a schematic view showing the projector, which is an LCD projector. The LCD projector includes LCD panels for red light, green light, and blue light. The LCD panels function as a light modulation device. The LCD projector includes an outer case 1, which accommodates optical elements that are described below.

The LCD projector includes an optical system, or optical engine, such as that shown in FIG. 1. The optical system includes an illumination optical system 10, a color separation optical system 20, a light modulation device 30, a color combining device 40, and a projection lens 50. The illumination optical system 10 collimates and emits white light from a light source lamp 11. The color separation optical system 20 separates the white color emitted from the illumination optical system 10 into light for a plurality of colors. The light modulation device 30 light-modulates the light for each color in accordance with image information. The color combining device 40 combines the modulated light for each color to generate image light. The projection lens 50 enlarges and projects the image light.

The illumination optical system 10 includes two light source lamps 11 that emit generally parallel light, two UV filters 12, two full reflection mirrors 13, a half mirror 14, an integrator lens 15, a polarizer 16 that converts light from the integrator lens 15 to predetermined polarized light components, and a condenser lens 17. The illumination optical system 10 illuminates the light modulation device 30, which serves as an illuminated region.

The two light source lamps 11 each include a light emission lamp, which emits radiant light beams, and a concave mirror, which emits the radiant light from the light emission beam into generally collimated light. A halogen lamp, a metal halide lamp, and the like that emit white light may be used as the light emission lamp. The light emitted from the two light source lamps 11 pass through the UV filters 12, which eliminate UV components. The light that has passed the UV filters is evenly distributed in the lateral direction by the two full reflection mirrors 13 and the half mirror 14 and then emitted toward the integrator lens 15.

The integrator lens 15 includes a first lens array and a second lens array. Each of the first and second lens arrays has a tetragonal contour and includes a plurality of small lenses laid out in a matrix. The polarizer 16 converts partial light, which corresponds to each small lens, from the integrator lens 15 into one type of polarized light. The polarized light is emitted from the condenser lens 17 to a dichroic mirror 21 of the color separation optical system 20.

The color separation optical system 20 includes first and second dichroic mirrors 21 and 22, first, second, and third full reflection mirrors 23a, 23b, and 23c, first and second relay lenses 24a and 24b, and first, second, and third condenser lenses 25, 26, and 27.

The modulation device 30 includes a red liquid crystal light valve 31, a green liquid crystal light valve 32, and a blue liquid crystal light valve 33, which function as first, second, and third light modulating means. The red liquid crystal light valve 31 modulates red light. The green liquid crystal light valve 32 modulates green light. The blue liquid crystal light valve 33 modulates blue light. In this embodiment, the light modulation device 30 further includes a Ye modulation element 34, which functions as a fourth light modulating means. The Ye modulation element 34 is a light modulation element that modulates yellow light components.

The color combining device 40 includes a cross dichroic prism 41, which functions as a color combining prism, and an aberration correction lens 42. The cross dichroic prism 41 combines the light for each color modulated by the light modulation device 30. The aberration correction lens 42 corrects the chromatic aberration at the projection lens 50.

In the color separation optical system 20, the first and second dichroic mirrors 21 and 22 separate the white light that has passed through the condenser lens 17 into red light, green light, and blue light. Yellow light is superimposed to the green light.

More specifically, the first dichroic mirror 21 transmits red light components of the white light emitted from the illumination optical system 10 and reflects green, yellow, and blue light components. The red light that passes through the first dichroic mirror 21 travels through the relay lens 24a and is reflected by the full reflection mirror 23a. Then, the red light travels through the condenser lens 25 and reaches the red liquid crystal light valve 31, which functions as the first light modulating means. The red light from the condenser lens 25 is elliptically polarized.

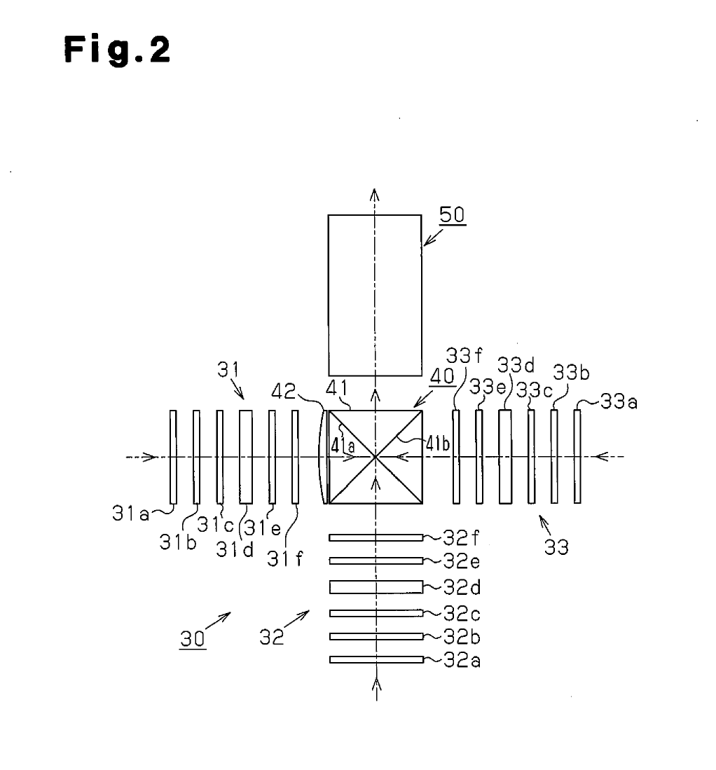

The red liquid crystal light valve 31 modulates red light components. As shown in FIG. 2, the red liquid crystal light valve 31 includes an entrance pre-polarization plate 31a (inorganic polarization plate), an entrance polarization plate 31b, an optical compensation plate 31c, an LCD panel 31d that includes a liquid crystal cell, an emission pre-polarization plate 31e, and an emission polarization plate 31f. The entrance pre-polarization plate 31a polarizes the elliptically polarized red light from the condenser lens 25 into red light that is linearly polarized in a fixed direction. The entrance polarization plate 31b transmits only the light linearly polarized in the fixed direction from the entrance pre-polarization plate 31b. The red light from the entrance polarization plate 31b travels through the optical compensation plate 31c and enters the LCD panel 31d. The LCD panel 31d modulates the red light based on an image signal. The optical compensation plate 31c compensates for birefringence in the LCD panel 31d. To reduce the load on the emission polarization plate 31f, the emission pre-polarization plate 31e decreases the amount of red light from the LCD panel 31d. The emission polarization plate 31e transmits only the light linearly polarized in the fixed direction from the emission pre-polarization plate 31e. In this manner, the entrance polarization plate 31b cooperates with the emission polarization plate 31f so that the light modulated by the LCD panel 31d is polarized only in the fixed direction.

As shown in FIG. 2, the green and blue liquid crystal light valves 32 and 33 differ from the red liquid crystal light valve 31 only in the modulated color of light and basically have the same structure as the red liquid crystal light valve 31. More specifically, the green liquid crystal light valve 32 includes an entrance pre-polarization plate 32a, an entrance polarization plate 32b, an optical compensation plate 32c, an LCD panel 32d, an emission pre-polarization plate 32e, and an emission polarization plate 32f, which respectively correspond to the entrance pre-polarization plate 31a, the entrance polarization plate 31b, the optical compensation plate 31c, the LCD panel 31d, the emission pre-polarization plate 31e, and the emission polarization plate 31f of the red liquid crystal light valve 31. In the same manner, the blue liquid crystal light valve 33 includes an entrance pre-polarization plate 33a, an entrance polarization plate 33b, an optical compensation plate 33c, an LCD panel 33d, an emission pre-polarization plate 33e, and an emission polarization plate 33f, which respectively correspond to the entrance pre-polarization plate 31a, the entrance polarization plate 31b, the optical compensation plate 31c, the LCD panel 31d, the emission pre-polarization plate 31e, and the emission polarization plate 31f of the red liquid crystal light valve 31.

In the color separation optical system 20, among the green, yellow, and blue light components reflected by the first dichroic mirror 21, the green and yellow light components are reflected by the second dichroic mirror 22. The green and yellow components than travel through the condenser lens 26 and enter the Yr modulation element 34.

The Ye modulation element 34 is an LCD panel including a liquid crystal cell that seals liquid crystal between glass substrates. The Ye modulation element 34 modulates and emits yellow light components based on an image signal. The emitted yellow light components enters the entrance polarization plate 32b of the green liquid crystal light valve 32 arranged at the emission side of the Ye modulation element 34. The entrance polarization plate 32b transmits only light components of the yellow light that conform to the transmission axis of the entrance polarization plate 32b. This controls the light intensity of the yellow components that pass through the Ye modulation element 34 and enter the green liquid crystal light valve 32. Further, the yellow and green light components that pass through the Ye modulation element 34 enter the green liquid crystal light valve 32.

The green light components entering the green liquid crystal light valve 32 are modulated by the LCD panel 32d based on an image signal and emitted to the cross dichroic prism 41. Further, the yellow light components entering the green liquid crystal light valve 32 are superimposed with the modulated green light components and emitted to the cross dichroic prism 41. The entrance pre-polarization plate 32a, the entrance polarization plate 32b, the optical compensation plate 32c, the emission pre-polarization plate 32e, and the emission polarization plate 32f of the green liquid crystal light valve 32 respectively function in the same manner as the entrance pre-polarization plate 31a, the entrance polarization plate 31b, the optical compensation plate 31c, the emission pre-polarization plate 31e, and the emission polarization plate 31f of the red liquid crystal light valve 31.

In the color separation system 20, the blue color components reflected by the first dichroic mirror 21 travels through the second dichroic mirror 22, the relay lens 24b, the full reflection mirrors 23b and 23c, and the condenser lens 27 before entering the blue liquid crystal light valve 33, which functions as the third light modulating means. The blue light components entering the blue liquid crystal light valve 33 is modulated by the LCD panels based on an image signal and emitted to the cross dichroic prism 41. The entrance pre-polarization plate 33a, the entrance polarization plate 33b, the optical compensation plate 33c, the emission pre-polarization plate 33e, and the emission polarization plate 33f of the blue liquid crystal light valve 33 respectively function in the same manner as the entrance pre-polarization plate 31a, the entrance polarization plate 31b, the optical compensation plate 31c, the emission pre-polarization plate 31e, and the emission polarization plate 31f of the red liquid crystal light valve 31.

The color combining device 40 includes the cross dichroic prism 41, which functions as the color combining prism. The cross dichroic prism 41 combines the red, green, and blue light modulated by the red, green, and blue liquid crystal light valves 31, 32, and 33 to form a color image. For this reason, the cross dichroic prism 41 includes reflections surfaces 41a and 41b that are laid out in the form of a cross. A film for reflecting red light is applied to the reflection surface 41a. A film for reflecting blue light is applied to the reflection surface 41b. Accordingly, the red light modulated by the red liquid crystal light valve 31 is reflected by the reflection surface 41a for red light and emitted toward the projection lens 50. Further, the blue light modulated by the blue liquid crystal light valve 33 is reflected by the reflection surface 41b for blue light and emitted toward the projection lens 50. The green light and yellow light modulated by the green liquid crystal light valve 32 is transmitted through the reflection surfaces 41a and 41b and emitted toward the projection lens 50.

The light that has been color-combined in this manner is projected from the projection lens 50 onto a projection surface such as a screen. In this case, the yellow light components are modulated based on an image signal and superimposed with green light. This increases the brightness of the projected image.

In a projector that includes such an optical system, the cross dichroic prism 41, which functions as the color combining prism, combines the images of the liquid crystal light valves 31, 23, and 33. The image is formed by the projection lens 50 on the projection surface. However, a chromatic aberration of magnification is normally present in the projection lens 50. As a result, the magnification rate differs between each color of light. This produces a convergence deviation between each color of light. Due to the convergence deviation, the enlargement magnification of red light decreases and the enlargement magnification of blue light increases. Further, the deviation between blue light and green light is relatively small, whereas the deviation between red light and green light is relatively large. Thus, in the present embodiment, to increase the enlargement magnification of only the red light to a level close to that of the green light without increasing costs, the aberration correction lens 42 is coupled to the cross dichroic prism 41 in a state pressed against a red light entrance surface of the cross dichroic prism 41.

A structure for coupling the aberration correction lens 42 will now be described in detail.

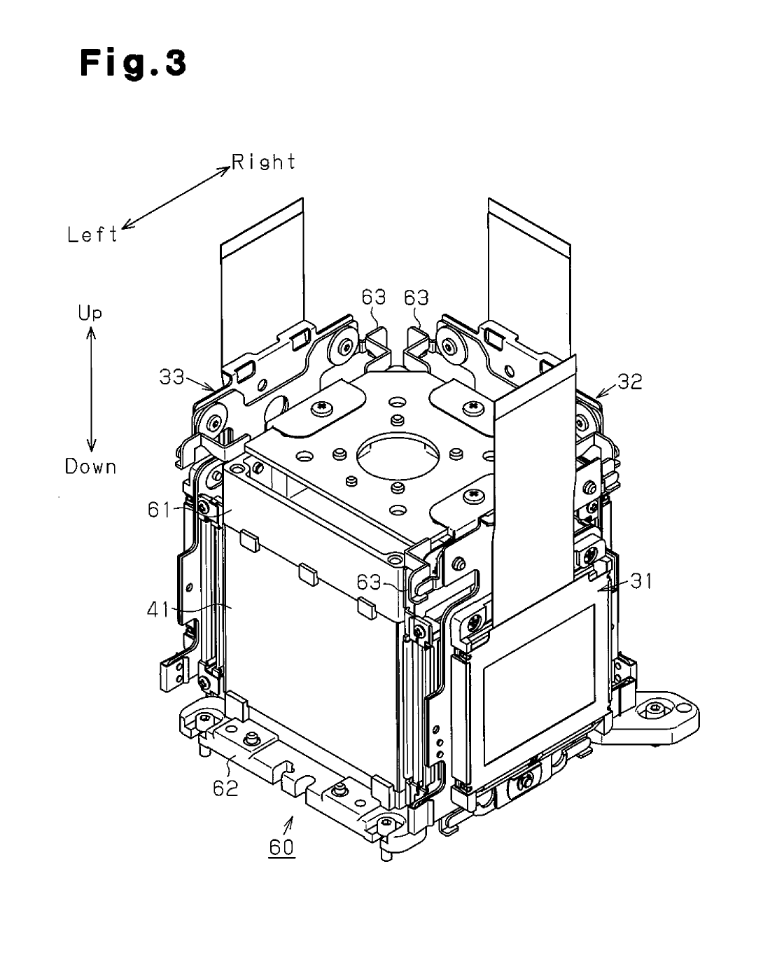

The periphery of the structure for coupling the aberration correction lens 42 to the cross dichroic prism 41 will be described with reference to FIGS. 3 to 9. In the description hereafter, the upward, downward, leftward, and rightward directions are as indicated in FIGS. 3 to 9.

Referring to FIGS. 3 to 9, the cross dichroic prism 41 is supported by a holder 60. Referring to FIG. 3, the optical components of the red liquid crystal light valve 31, the green liquid crystal light valve 32, and the blue liquid crystal light valve 33, which function as light modulating means, are coupled to the holder 60 and form a color combining prism unit.

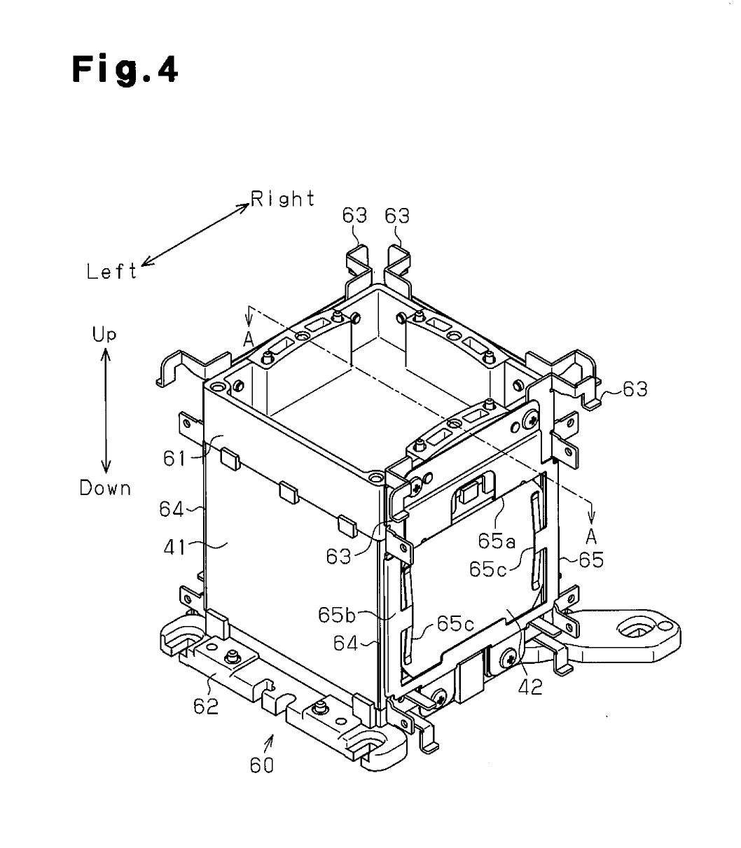

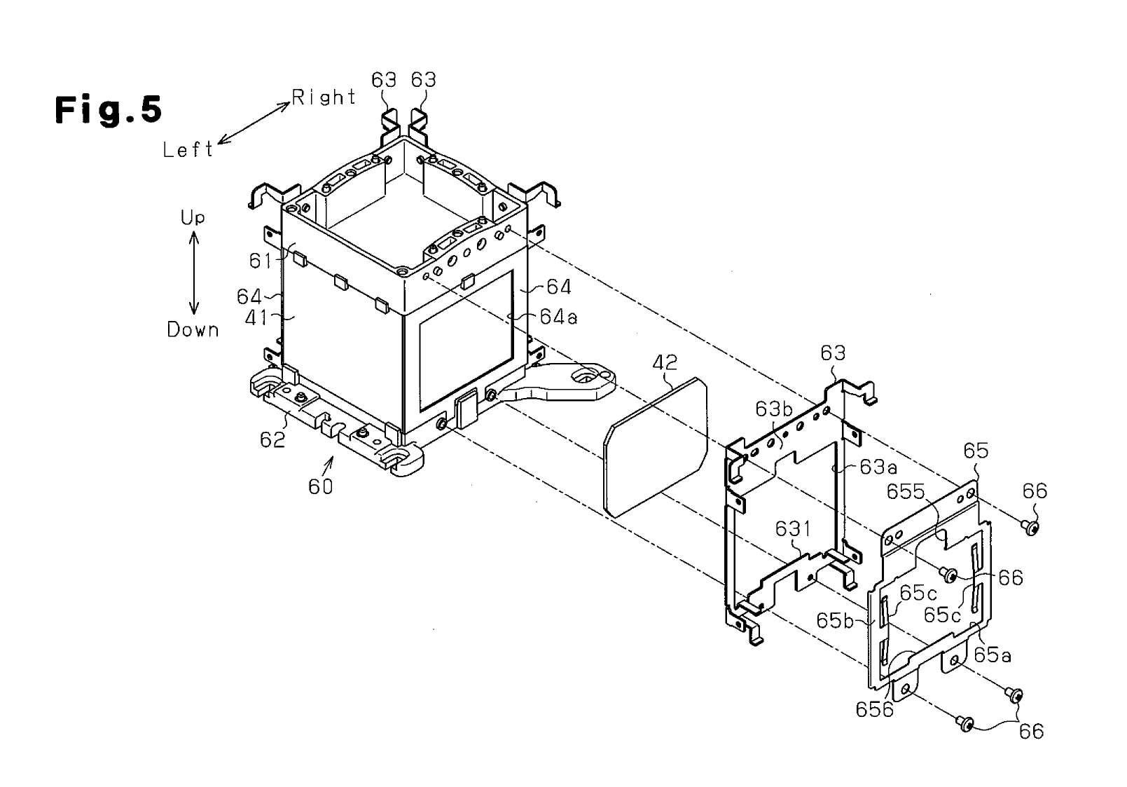

FIG. 4 is a perspective view showing a state in which the optical components are removed from the structure shown in FIG. 3. As shown in FIG. 4, the holder 60 includes an upper holder 61, a lower holder 62, and side holders 63, which couple the upper holder 61 and the lower holder 62. As shown in FIG. 5, the holder 60 includes the aberration correction lens 42 and light shields 64.

Referring to FIG. 5, each side holder 63 includes a tetragonal opening 63a and a frame 63b, which extends around the opening 63a. Light from a corresponding one of the liquid crystal light valves 31, 32, and 33 passes through the opening 63a. The frame 63b couples the upper holder 61 and the lower holder 62.

Each side holder 63 is coupled in contact with one of three light entrance surfaces of the cross dichroic prism 41 with the light shield 64 arranged between the frame 63b and the light entrance surface. The opening 63a is larger than the aberration correction lens 42. The opening 63a has a width that is slightly larger than that of the aberration correction lens 42. The opening 63a is formed to provide a larger margin of space in the vertical direction than the lateral direction. A projection 631 extends into the opening 63a from a lower part of the frame 63b. The projection 631 is used as a reference point for the vertical direction when coupling the aberration correction lens 42.

Although not clearly shown in FIG. 3, optical components of the red, green, and blue liquid crystal light valves 31, 32, and 33 are coupled to the frames 63b of the side holders 63.

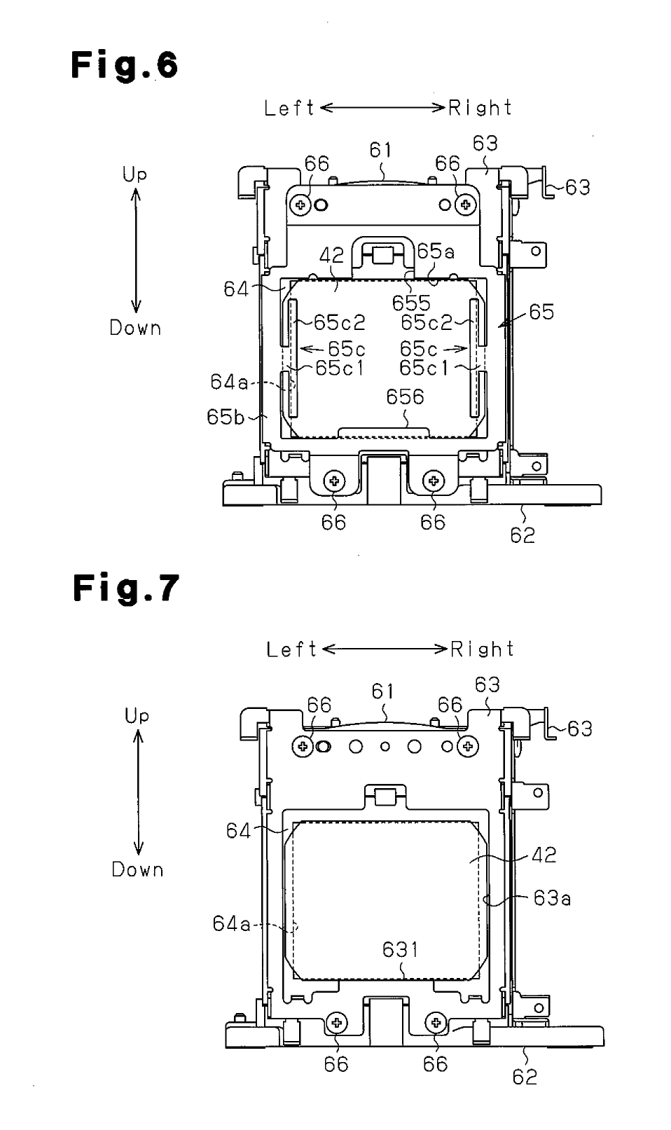

As shown in FIG. 5, each light shield 64 is a frame-shaped flat plate including a tetragonal light passage 64a. The modulated light from the corresponding one of the liquid crystal light valves 31, 32, and 33 passes through the light passage 64a. Each light shield 64 shields light leaking from a frame supporting the corresponding one of the emission polarization plates 31f, 32f, and 33f and light reflected by the reflection surfaces 41a and 41b of the cross dichroic prism 41. The light shield plate 64 is formed by a thin metal plate colored in black. As shown in FIGS. 6 to 9, the sides of the light passage 64a are shorter than the sides of the opening 63a in each side holder 63.

The light shield 64 is arranged between the side holder 63 for red light and the light entrance surface of the cross dichroic prism 41. As a result, the aberration correction lens 42 is held in contact with the light entrance surface of the cross dichroic prism 41. The aberration correction lens 42 is fixed in a state resiliently pressed by a pressing member 65.

Referring to FIG. 5, the aberration correction lens 42 is tetragonal and includes chamfered corners as viewed from the light entrance side. The aberration correction lens 42 is a planoconvex glass lens including a flat surface facing toward the cross dichroic prism 41 and an outwardly bulged opposite surface, which is gradually curved. The sides of the aberration correction lens 42 are longer than the sides of the light passage 64a in each light shield 64. Further, the aberration correction lens 42 is tetragonal and includes sides that are shorter than the opening 63a in each side holder 63. As shown in FIGS. 6 and 7, in a state in which the aberration correction lens 42 is in contact with the light entrance surface of the cross dichroic prism 41, the inner edges of the frame 63b in the corresponding side holder 63 holds the outer edges of the aberration correction lens 42 in position.

The pressing member 65 is formed by processing a sheet of resilient metal, such as stainless steel. The pressing member 65 includes a tetragonal light passage 65a, which is formed in the central part, and a frame 65b, which surrounds the passage 65a. The light from the red liquid crystal light valve 31 passes through the light passage 65a. The frame 65a is overlapped with the frame 63b of the corresponding side holder 63. At the circumference of the light passage 65a where light from the liquid crystal light valve 31 passes, a pressing tab 65c, or pressing portion, projects into the light passage 65a from each side of the frame 65b. The pressing tabs 65c press the peripheral portion of the aberration correction lens 42 against the cross dichroic prism 41.

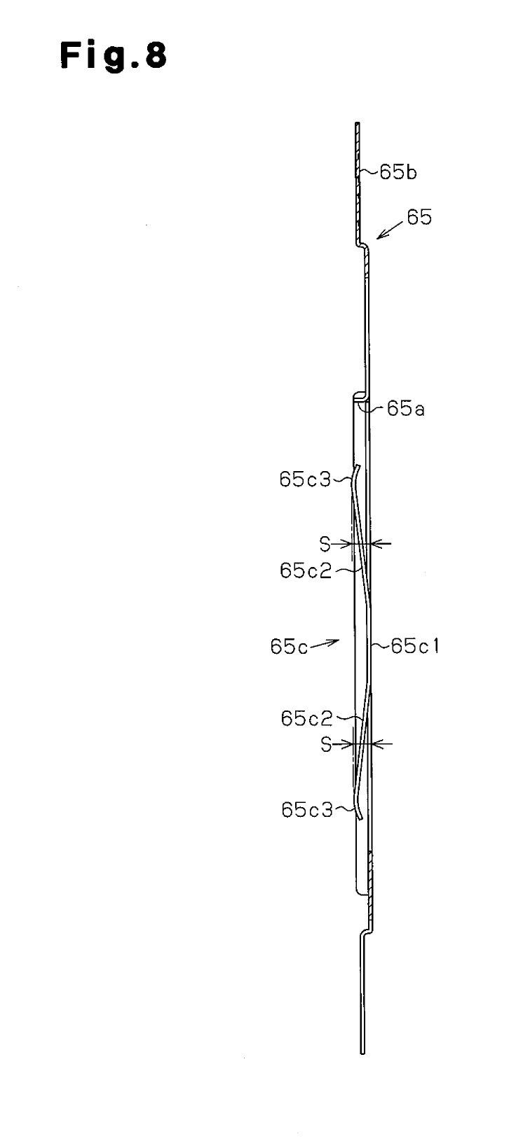

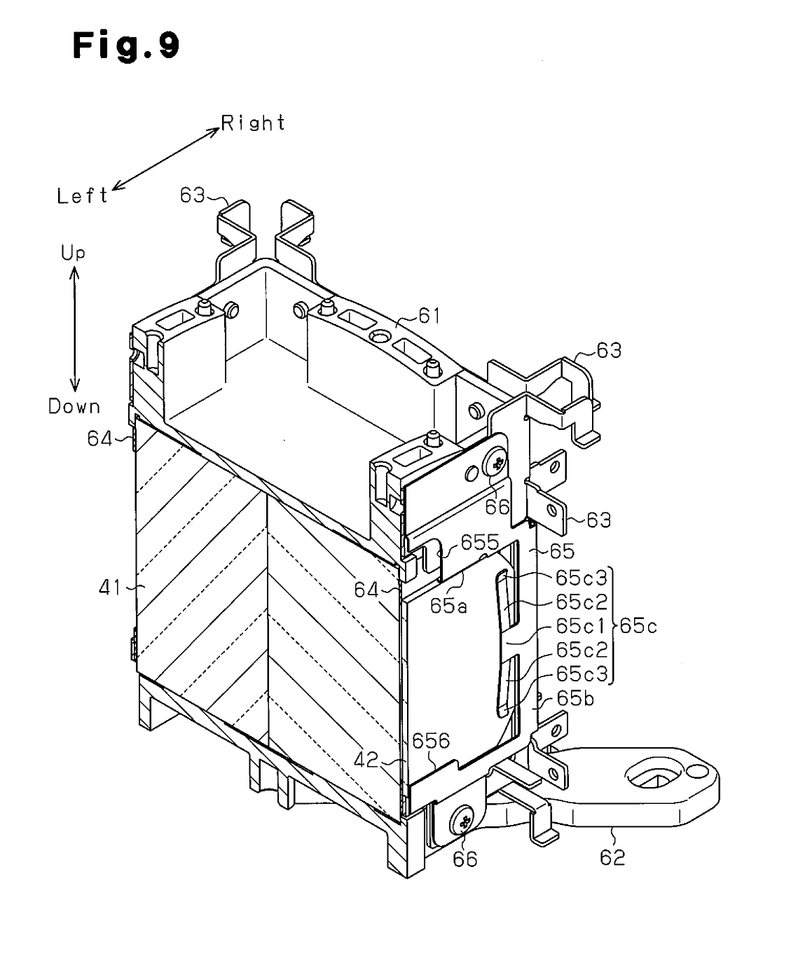

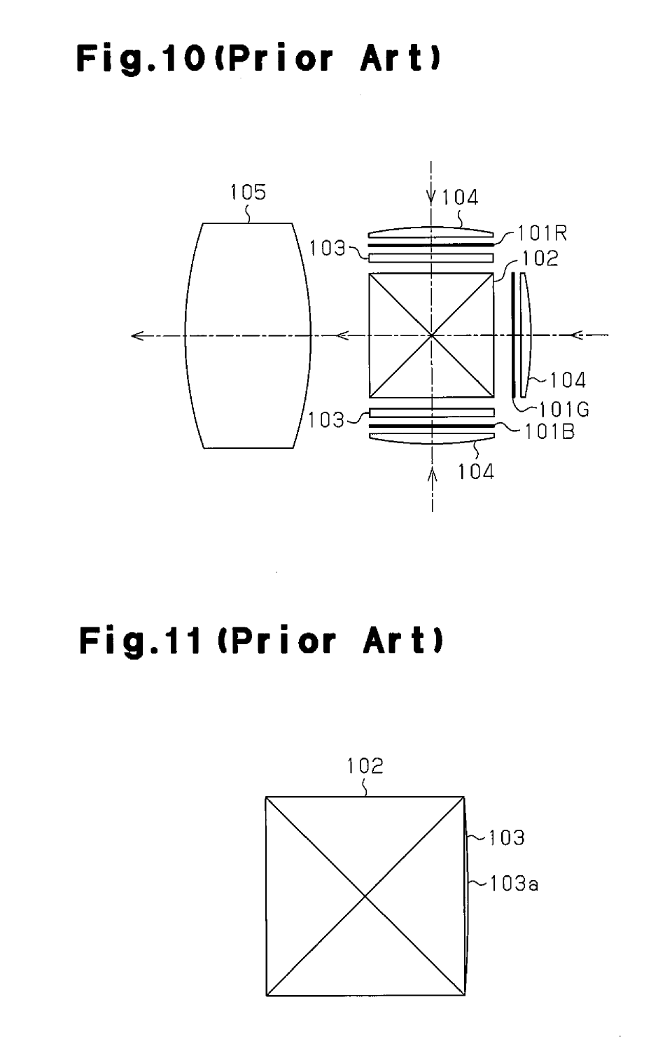

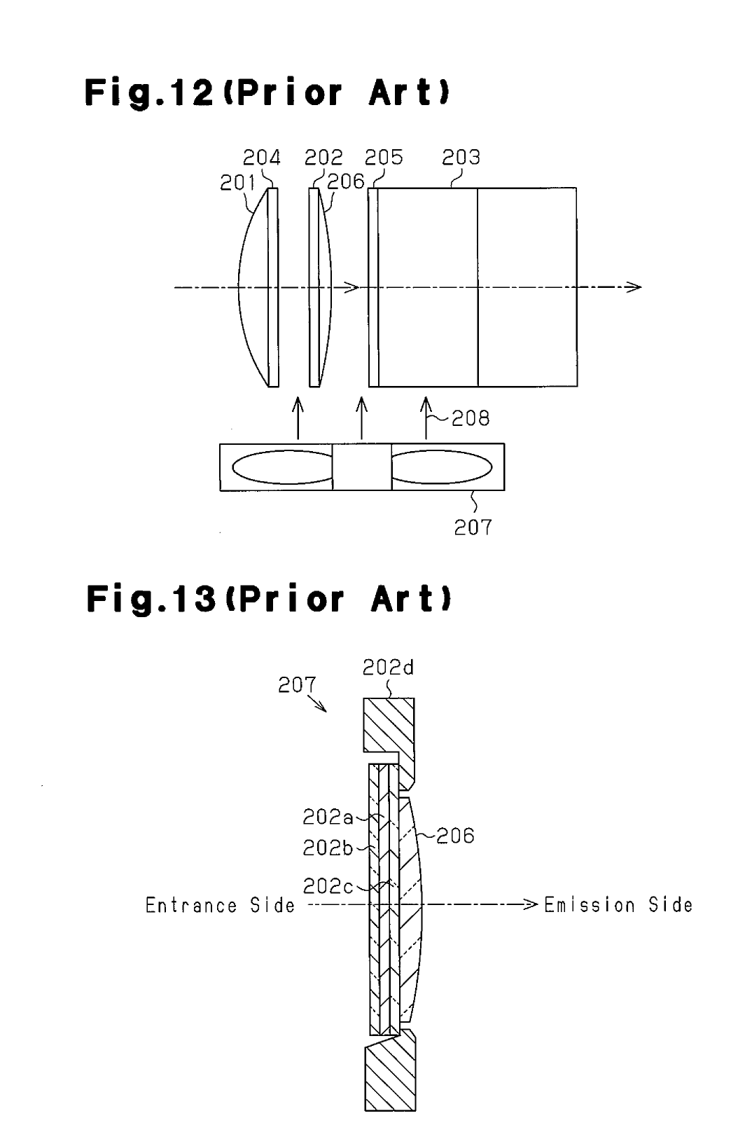

The pressing tab 65c includes a connection portion 65c1, an arm portion 65c2, and abutment portions 65c3. The connection portion 65c1 is connected to the frame 65b. The arm 65c2 is strip-shaped, has a constant width, and extends from the connection portion 65c parallel to the frame 65b. The abutment portions 65c3 are formed on the two opposite ends of the arm 65c2. The abutment portions 65c3 abut and press the light emission surface of the aberration correction lens 42. As shown in FIG. 9, the connection portion 65c1 projects into the light passage 65a from the middle part of the corresponding side (specifically, the left or right side) of the light passage 65a. The arm 65c2 extends from the connection portion 65c1 in upper and lower directions. As shown in FIG. 8, the abutment portions 65c3 are bent toward the cross dichroic prism 41 from the connection portion 65c1 by a predetermined dimension S. Further, each abutment portion 65c3 is smoothly curved at the part that presses the aberration correction lens 42 against the cross dichroic prism 41. Accordingly, the abutment portions 65c3 of the pressing tabs 65c contact the aberration correction lens 42 with suitable resilient force in the direction of the optical axis.

Screws 66 fasten the upper and lower parts of the frame 65b to the upper and lower holders 61 and 62 and fix the pressing member 65 together with the side holder 63. A cutout portion 655 arranged in the upper part of the frame 65b defines an upper part of the light passage 65a. The cutout portion 655 allows for insertion of one's fingers when handling the pressing member 65. Further, a projection 656 projects into the light passage 65a from the lower part of the frame 65b to support the lower end of the aberration correction lens 42.

The aberration correction lens 42 is coupled to the cross dichroic prism 41 as described below.

First, the light shields 64 are adhered to the three light entrance surfaces of the cross dichroic prism 41. Then, the lower holder 62 is arranged on the lower part of the cross dichroic prism 41, and the upper holder 61 is placed on the upper part of the cross dichroic prism 41. Further, the side holders 63 for green light and blue light are fastened by screws to the upper holder 61 and the lower holder 62. This couples the upper and lower holders 61 and 62 to the side holders 63 with the cross dichroic prism 41 contained therein. In this state, the light shields 64 are arranged between the frames 63b of the side holders 63 and the light entrance surfaces of the cross dichroic prism 41. When coupling of the side holder 63 for red light with the upper holder 61 and lower holder 62, the pressing member 65 for coupling the aberration correction lens 42 must be fastened together. Thus, at this stage, the side holder 63 for red light, the upper holder 61, and the lower holder 62 are arranged at predetermined positions or loosely fastened.

Then, the aberration correction lens 42 is coupled to the side holder 63 for red light in the opening 63a with the flat side of the aberration correction lens 42 pressed against the cross dichroic prism 41. Here, the lower end of the aberration correction lens 42 abuts the upper end of the projection 631 in the side holder 63. Further, the center of the aberration correction lens 42 in the lateral direction is aligned with the center of the opening 63a in the lateral direction. In this manner, the aberration correction lens 42 is coupled to the red light entrance surface of the cross dichroic prism 41 with the light shield 64 arranged in between. Further, the side holder 63 and the screws 66 fasten the pressing member 65 to the cross dichroic prism 41 to press the aberration correction lens 42 against the light entrance surface of the cross dichroic prism 41. By fixing the cross dichroic prism 41 to the upper holder 61 and the lower holder 62, the aberration correction lens 42 is coupled to the red light entrance surface of the cross dichroic prism 41. In this manner, after coupling the side holders 63 to the three entrance surfaces of the cross dichroic prism 41, the liquid crystal light valves 31, 32, and 33 are coupled to the side holders 63.

The LCD projector of the above embodiment has the advantages described below.

(1) The aberration correction lens 42 is resiliently pressed by the pressing member 65 and fixed to the red light entrance surface of the color combining prism (e.g., cross dichroic prism 41). Thus, an unnecessary clearance is not formed between the aberration correction lens 42 and the color combining prism. This prevents enlargement of the area occupied by the optical engine when coupling the aberration correction lens 42.

(2) The aberration correction lens 42 is coupled to a light entrance surface of the color combining prism without using an adhesive agent. Thus, there is no effect on the aberration correction lens 42 that would be caused by deterioration of an adhesive agent.

(3) The aberration correction lens 42 is coupled to the light entrance surface of the color combining prism by pressing and fixing the aberration correction lens 42 to the light entrance surface of the color combining prism with the pressing member 65. Thus, the aberration correction lens 42 is coupled to the light entrance surface of the color combining prism in an inexpensive manner without using sophisticated techniques.

(4) The aberration correction lens 42 is held in a state pressed against the light entrance surface of the cross dichroic prism 41 that functions as the color combining prism. Thus, the aberration correction lens 42 is held with high accuracy on a plane that is orthogonal to the optical axis.

(5) The aberration correction lens 42 is arranged in the opening of the side holder 63 so that the outer edges of the aberration correction lens 42 is held in position by the inner edges of the side holder 63 defining the opening 63a. Thus, the position of the aberration correction lens 42 in the plane orthogonal to the optical axis is highly accurate and easily maintained.

(6) Each light shield 64 is coupled between the frame 63b of the corresponding side holder 63 and the corresponding light entrance surface of the cross dichroic prism 41. This prevents the leakage of light from the frames of the emission polarization plates 31f, 32f, and 33f and the leakage of reflection light from the reflection surfaces 41a and 41b of the cross dichroic prism 41. As a result, an image is formed with good quality.

(7) The aberration correction lens 42 is pressed by the pressing tabs 65c of the pressing member 65 against the light entrance surface of the color combining prism outside the portion through which light from the red liquid crystal light valve 31 passes. The aberration correction lens 42 is accurately arranged orthogonal to the optical axis without interfering with the passage of light from the red liquid crystal light valve 31. Accordingly, the aberration correction lens 42 accurately corrects a convergence deviation between red light, green light, and blue light.

(8) The pressing tabs 65c of the pressing member 65 includes the two opposing connection portions 65c1 and the arm 65c2 extending in opposite directions from the two sides of each connection portion 65c1. The pressing tabs 65c further include the abutment portions 65c3 formed on each end of the arms 65c2 to abut and press the aberration correction lens 42. Accordingly, the aberration lens 42 is pressed at four symmetrical positions relative to the center of the aberration correction lens 42. This rigidly couples the aberration correction lens 42 to the light entrance surface of the color combining prism.

(9) The pressing member 65 is formed by pressing a metal sheet. The abutment portions 63c3 are bent toward the color combining prism by the predetermined dimension from the surface of the frame 65b that is overlapped with the frame 63b of the side holder 63. Thus, the pressing member 65 is easily formed by processing a metal sheet. Further, such a structure does not increase the size of the pressing member 65 in the direction of the optical axis and thereby prevents enlargement of the optical engine.

(10) In the aberration correction lens 42, the surface facing toward the color combining prism is flat and the opposite side is an outwardly bulged surface. This ensures that the aberration correction lens 42 is arranged orthogonal to the optical axis. Further, the pressing tabs 65c of the pressing member 65 contact the bulged surface of the aberration correction lens 42. Thus, a slight pressing force acts toward the center of the aberration correction lens 42. This further ensures prevention of displacement of the aberration correction lens 42 in a plane orthogonal to the optical axis of the aberration correction lens 42.

It should be apparent to those skilled in the art that the present invention may be embodied in many other specific forms without departing from the spirit or scope of the invention. Particularly, it should be understood that the present invention may be embodied in the following forms.

The application of the present invention is not limited to an LCD projector. The present invention may be applied to any projector that produces a chromatic aberration of magnification when generating different colors of light with optical systems and combining and projecting the light. Such a projector may be one that uses a laser light source functioning as a light source lamp for each color of light. Further, a reflective LCD panel may be used as the modulating means.

In the above embodiment, the aberration correction lens 42 is used for only red light but may also be used for other colors of light. For example, an aberration correction lens that decreases the magnification may be used for blue light. Alternatively, an aberration correction lens may be used for each of red light, green light, and blue light to correct and converge the aberration magnification. In such cases, the coupling of the aberration correction lens is changed as required.

In the above embodiment, the aberration correction lens 42 is formed from glass but not limited in such a manner and may be formed from a heat resistant resin. In such a case, the aberration correction lens 42 may be molded from plastic. This would facilitate the production of the aberration correction lens 42.

In the above embodiment, the light shield 64 is formed from metal but not limited in such a manner and may be formed from other materials as long as light can be shielded. For example, the light shield 64 may be formed from a heat resistant resin.

In the above embodiment, the pressing member 65 is formed by processing a sheet of stainless steel but not limited in such a manner. For example, the pressing member 65 may be molded from an elastic heat resistant material.

The projector according to the present invention may be used as an image display system for various types of facilities, such as a home theater, a conference room, a training room, a classroom, a recreation room, an exhibition room, and a studio.

The present examples and embodiments are to be considered as illustrative and not restrictive, and the invention is not to be limited to the details given herein, but may be modified within the scope and equivalence of the appended claims.

1. A projector comprising:
three light valves respectively corresponding to red light, green light, and blue light, wherein the light valves modulate the light of the corresponding color;
a color combining prism that combines the modulated light from the light valves, wherein the color combining prism includes three light entrance surfaces respectively corresponding to the light valves to receive the modulated light of the corresponding color;
a projection lens that enlarges and projects the combined light from the color combining prism;
at least one aberration correction lens arranged in at least one of three paths respectively corresponding to the red light, green light, and blue light and extending from the light valves to the light entrance surfaces, wherein the aberration correction lens corrects a chromatic aberration of magnification of the projection lens; and
at least one pressing member that resiliently presses and fixes the at least one aberration correction lens to the light entrance surface of the color combining prism.

2. The projector according to claim 1, wherein the color combining prism includes an upper surface and a lower surface, each adjacent to the light entrance surfaces of the color combining prism, and the projector further comprises:
an upper holder that supports the upper surface of the color combining prism;
a lower holder that supports the lower surface of the color combining prism; and
three side holders that respectively support the light entrance surfaces of the color combining prism, wherein each of the three side holders includes a frame provided with a hole through which light from the corresponding one of the light valves passes,
the frame is coupled to the upper holder and the lower holder, and
the at least one of the aberration correction lens is arranged in the frame of one of the side holders so that an inner edge of the frame holds the aberration correction lens in position.

3. The projector according to claim 2, further comprising three light shields respectively arranged between the light entrance surfaces of the color combining prism and each frame of the three side holders or the at least one aberration correction lens, wherein
the light shields hold the side holders in contact with the light entrance surfaces of the color combining prism,
each of the light shields is formed from a thin plate that prevents light leakage and includes an outer surface facing away from the corresponding light entrance surface of the color combining prism, and
the at least one aberration correction lens is fixed in contact with the outer surface of the corresponding light shield.

4. The projector according to claim 3, wherein the pressing member includes
a light passage through which light from the corresponding light valve passes,
a frame surrounding the light passage and formed to overlap the frame of the corresponding side holder, and
a pressing portion projecting into the light passage from the frame to press a peripheral portion of the aberration correction lens against the corresponding light entrance surface of the color combining prism at a peripheral portion of the light passage through which the light from the corresponding light passages passes, wherein the pressing portion includes
a connection portion connected to a middle part of each of two opposing sides that define the light passage in the frame,
an arm extending from two opposite sides of the connection portion parallel to the sides, and
an abutment portion arranged on each end of the arm to abut and press the aberration correction lens.

5. The projector according to claim 4, wherein the abutment portion of the pressing member is bent by a predetermined dimension toward the color combining prism from a position overlapped with the frame of the corresponding side holder in the frame of the pressing member.

6. The projector according to claim 4, wherein the aberration correction lens is a planoconvex lens including a flat surface facing toward the color combining prism and an opposite outwardly bulged convex surface.
